(19) United States
(12) Patent Application Publication
(10) Pub. No.: US 2012/0179607 A1
(43) Pub. Date: Jul. 12, 2012

(54) MULTI-MERCHANT / ITEM STORED VALUE ACCOUNT TRANSACTIONS

(75) Inventors: Basil Munir Abifaker, San Diego, CA (US); Stephen Jones, Escondido, CA (US)

(73) Assignee: TRANSACTION WIRELESS, INC.

(21) Appl. No.: 12/986,834

(22) Filed: Jan. 7, 2011

(51) Int. Cl. G06Q 20/00; G06Q 40/00

(52) U.S. Cl. 705/41; 705/44; 235/380

(57) ABSTRACT

The current subject matter provides techniques in which stored value from a stored value account can be redeemed at two or more backend stored value account processors in either a single transaction or multiple transactions. Techniques are also described for redeeming stored value from stored value accounts that correspond to bundled items. Related apparatus, systems, techniques and articles are also described.

### TECHNICAL FIELD

The subject matter described herein relates to the use of stored value accounts to purchase bundled products or services and/or to the use of a single stored value identifier in connection with two or more stored value card accounts.

### BACKGROUND

Gift card and stored value programs are typically tied to a single value or processor creating a one-to-one relationship between an account number and a value for a single merchant/retailer. Stated differently, a consumer is only able to use a stored value card at the merchant issuing such stored value card. In addition, while a stored value card might be associated with a single product or service (e.g., a massage, etc.), such stored value cards are not specifically associated with multiple products or services which can be individually redeemed. Such arrangements provide a restricted user experience which can limit potential sales of stored value cards.

### SUMMARY

In one aspect, a redemption authorization request associated with a stored value account is received from a merchant system by a transaction server. The request identifies a merchant associated with the merchant system, a redemption amount, and an identification associated with the stored value account. The transaction server accesses at least one database table to map the identification to one of a plurality of backend processor systems. The stored value account is able to redeem stored values from each of the plurality of backend processor systems. Thereafter, the transaction server polls the mapped backend processor system to redeem the redemption amount from the stored value account for the benefit of the merchant system. Subsequently, the transaction server provides data approving or rejecting the request based on the polling to the merchant system.

The identification associated with the stored value account can be a mobile phone number. A visual representation of the stored value account can be displayed on a mobile phone associated with the mobile phone number. The visual representation can reflect whether the request was approved (e.g., by updating a balance, etc.) or rejected. In cases in which a mobile phone is used, the mobile phone can be used to have the user authenticate the transaction (e.g., by responding to an SMS/MMS, activating a GUI control button on a native application, etc.).

The identification associated with the stored value account can be an account number obtained by swiping a physical stored value card at the merchant system or at a swiping device coupled to the merchant system. In addition, the stored value card can be placed in proximity to a reader device (e.g., RFID, etc.) at the merchant system that does not require contact with the stored value card. The identification associated with the stored value account can be obtained by scanning an electronic representation of a stored value card (e.g., the stored value card can be rendered on a display of a mobile phone, tablet computer, etc.).

In another aspect, a redemption authorization request associated with a stored value account is received from a merchant system by a transaction server. The request identifies a merchant associated with the merchant system, a redemption amount, and an identification associated with the stored value account. The transaction server accesses at least one database table to map the identification to at least two backend processor systems and to associate a portion of the redemption amount to each of the least two backend processor system. Thereafter, the transaction server polls the at least two mapped backend processor systems to redeem the associated portion of the redemption amount from the stored value account for the benefit of the merchant system. Subsequently, the transaction server provides data to the merchant system approving or rejecting the request based on the polling.

In a further interrelated aspect, a redemption authorization request associated with a stored value account is received from a merchant system by a transaction server. The request identifies a merchant associated with the merchant system, a redemption amount, and an identification associated with the stored value card. Thereafter, the transaction server accesses a database table to map the redemption amount with at least one of a plurality of pre-defined items and to map the identification with at least one of a plurality of backend processor systems. The transaction server then polls the mapped at least one backend processor system to redeem the redemption amount from the stored value card for the benefit of the merchant system. The transaction server then updates the at least one database table to reflect the redemption of stored value corresponding to the mapped at least one pre-defined item. In addition, the transaction server provides data to the merchant system approving the request.

A visual representation of a payment card corresponding to the stored value account can be updated to reflect the redemption of the at least one pre-defined item. The database tables can map the identification to at least two backend processor systems and associates a portion of the redemption amount to each of the least two backend processor systems, and relatedly, the transaction server can poll the at least two mapped backend processor systems to redeem the associated portion of the redemption amount from the stored value account for the benefit of the merchant system.

In yet a further interrelated aspect, a system includes a merchant system comprising at least one data processor, a transaction server comprising at least one data processor, a plurality of backend processor systems each comprising at least one data processor, and at least one data store. A redemption authorization request associated with a stored value account is received from the merchant system by the transaction server. The request identifies a merchant associated with the merchant system, a redemption amount, and an identification associated with the stored value account. At least one database table stored in the at least one data store is accessed by the transaction server to map the identification to one of a plurality of backend processor systems. The stored value account is able to redeem stored values from each of the plurality of backend processor systems. The mapped backend processor system is polled by the transaction server to redeem the redemption amount from the stored value account for the benefit of the merchant system. Data approving or rejecting the request based on the polling is provided by the transaction server to the merchant system.

Articles of manufacture are also described that comprise computer executable instructions permanently stored on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. Operations can be computer implemented in that they are implemented by at least one data processor within a single computing system or distributed across two or more computing systems.

The subject matter described herein provides many advantages. For example, in some implementations, the current subject matter allows a single stored value account to be used in conjunction with multiple backend stored value processors either as part of a single transaction or as part of two or more transactions. The current subject matter can also allow a user of a single stored value card to redeem a series of predefined products/services which can optionally be provided by two or more merchants.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A is a process flow diagram illustrating a method in which stored value associated with a stored value account can be redeemed at two or more backend stored value backend processors in separate transactions;

FIG. 1B is a process flow diagram illustrating a method in which stored value associated with a stored value account can be redeemed at two or more backend stored value backend processors as part of a single transaction;

FIG. 1C is a process flow diagram illustrating a method in which bundled items can be redeemed from a stored value account as part of a single transaction or as part of multiple transactions;

FIG. 2 is a diagram illustrating an architecture including a POS terminal, a transaction terminal and a plurality of backend processors;

FIG. 3 is a diagram illustrating association of a stored value account with two or more pre-defined items;

FIG. 4 is a diagram illustrating association of a stored value account with two or more pre-defined items redeemable across differing backend processors; and

FIG. 5 is a diagram illustrating a stored value card that includes visual elements characterizing redemption of pre-defined items.

Like reference numerals reference like items.

### DETAILED DESCRIPTION

Traditional stored value programs (e.g., gift cards, loyalty cards, etc.) are typically tied to a single value or processor creating a one-to-one relationship between an account number and a value for a single merchant/retailer. As used herein, account numbers can take the form of a physical card with an associated account number or they can take the form of an electronic representation of a physical card (which can be delivered on any computing device including desktops, tablets, mobile phones, electronic displays, point of sale systems, etc.). A physical card can include any identification means including embossed numbering, a magnetic strip, RFID, and other technologies which can be detected by a reader such as a swiper, bar code scanner, RFID detector, etc. Data characterizing the stored value card can also be incorporated or otherwise displayed in connection with various social networking services (e.g., as part of a user profile page, etc.) including FACEBOOK and the like (see, for example, U.S. patent application Ser. No. 12/022,127 entitled: “Integration of Gift Card Services for Mobile Devices and Social Networking Services”, the contents of which are hereby fully incorporated by reference). In some implementations, the account number can comprise or be linked to a mobile phone number such as the techniques described in U.S. Pat. No. 7,711,620 entitled “Gift Card Services for Mobile Devices”, the contents of which are hereby incorporated by reference. Request for redemption as described herein relate to use of stored value such as currency provided as a gift card from a particular merchant or merchants or frequent flier miles as part of an airline loyalty program.

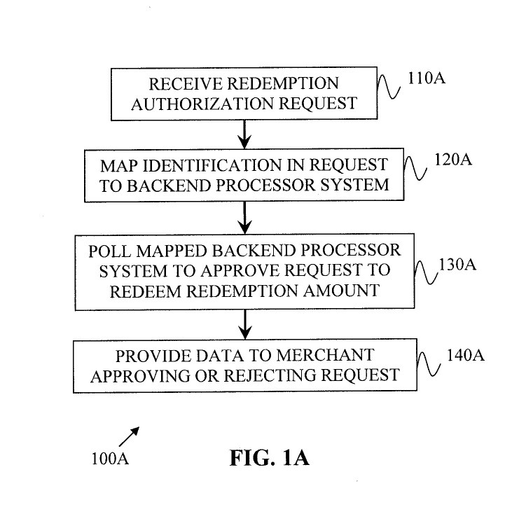

FIG. 1A is a diagram 100A illustrating a method in which stored value associated with a stored value account can be redeemed at two or more backend stored value backend processors in separate transactions. The backend stored value backend processors store and manage stored values for stored valued account and allow for redemption when there are sufficient balances of corresponding stored values. Referring to FIG. 1A, a redemption authorization request for a transaction that is associated with a stored value account is received, at 110A, from a merchant system by a transaction server. The request identifies a merchant associated with the merchant system, a redemption amount, and an identification associated with the account. Thereafter, at 120A, the transaction server accesses at least one database table to map the identification to one of a plurality of backend processor systems. The stored value account being able to redeem stored values from each of the plurality of backend processor systems. The transaction server, at 130A, polls the mapped backend processor system to redeem the redemption amount from the stored value account for the benefit of the merchant system (or its designee). Once this redemption has been finalized, the transaction server, at 140A can provide data to the merchant system approving or rejecting the transaction based on the polling.

FIG. 1B is a process flow diagram 100B illustrating a method in which a stored value account can be redeemed at two or more backend stored value backend processors as part of a single transaction. At 110B, a redemption authorization request for a transaction that is associated with a stored value account is received from a merchant system by a transaction server. The request identifies a merchant associated with the merchant system, a redemption amount, and an identification associated with the stored value account. The transaction server, at 120B, accesses at least one database table to map the identification to at least two backend processor systems and to associate a portion of the redemption amount to each of the least two backend processor systems (i.e., to apportion the redemption amount). Thereafter, at 130B, the transaction server polls the at least two mapped backend processor systems to redeem the associated portion of the redemption amount from the stored value account for the benefit of the merchant system. The transaction server, at 140B, provides data to the merchant system approving or rejecting the request based on the polling.

FIG. 1C is a process flow diagram 100C illustrating a method in which bundled items can be redeemed from a stored value account as part of a single transaction or as part of multiple transactions. Items refer to anything which an individual might want to exchange for stored value including tangible and intangible products and services. At, 110C, a redemption authorization request for a transaction is received from a merchant system by a transaction server. The request identifies a merchant associated with the merchant system, a redemption amount, and an identification associated with the stored value account. Subsequently, at 120C, the transaction server accesses at least one database table to map, at least, the redemption amount with at least one of a plurality of pre-defined items and to map the identification with one of a plurality of backend processor systems. The transaction server then, at 130C, polls the mapped backend processor system to redeem the redemption amount from the stored value account for the benefit of the merchant system or its designee. The transaction server later, at 140C, updates the at least one database table to reflect the redemption of stored value corresponding to the mapped at least one pre-defined item. The transaction server, at 150C, additionally provides data approving the request to the merchant system. Optionally, in some implementations, at 160C, a visual representation of a payment card corresponding to the stored value account can be updated to reflect the redemption of the at least one pre-defined item.

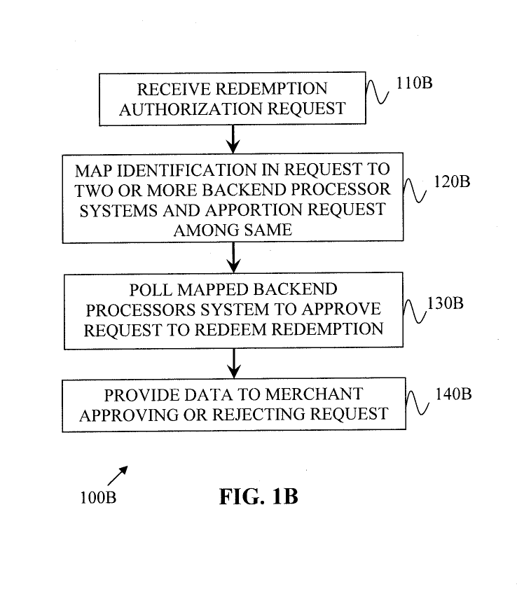

FIG. 2 is a diagram 200 illustrating the use of a stored value card at two or more merchants (each with different backend processing systems). With this scenario, a consumer need only provide a single stored value account identifier (e.g., stored value card, telephone number, etc.) to participate in multiple merchant/retail stored value programs. For example, the single identifier could be a single payment card to redeem “Dinner and a Movie” using a (i) movie theater chain; and (ii) restaurant chain combo stored value program. With reference to FIG. 2, a point of sale terminal 210 obtains an account identifier associated with a stored value account. The POS terminal 210 can, for example, include a magnetic card reader, a barcode reader, an alphanumeric keypad, etc. to either obtain the account number directly or to obtain an identifier (such as a telephone number) associated with the account number. The POS terminal 210 via web service (or other type of call) accesses a TW server 220 (also referred to elsewhere simply as a transaction server) which includes or is coupled to a database table mapping the identifier to one or more backend processors 230, 232, 234 (which are associated with different merchant stored value programs). The TW server 220 can poll the appropriate backend processor(s) 230, 323, 234 (as defined by the at least one mapping table) so that the corresponding accounts can be appropriately deducted per the transaction.

Referring still to FIG. 2, a single account number (TW_Account_Number) can be registered/mapped on the TW server 220 to multiple account numbers (Account_Number:1, Account_Number:2, Account_Number:N) for multiple merchants (Merchant:1, Merchant:2, Merchant:N) with stored values (Value:1, Value:2, Value:N) across multiple backend processors (Processor:1 230, Processor:2 232, Processor:N 234). A user attempts to redeem Value:1 at Merchant:1 POS system 210. The POS system 210 passes Value:1, Merchant:1 identifier and Account_Number:A to TW server 220. The TW Server 220 looks up TW_Account_Number and Merchant:1 and makes a call to Backend Processor:1 230 with Account_Number1 to redeem Value:1. The TW server 220 then sends data to the POS system 210 indicating that the proposed transaction was approved. Similarly, a user attempts to redeem Value:N at Merchant:N POS system (not shown) and such POS system passes Merchant:N identifier and TW_Account_Number to the TW server 220. The TW Server 220 looks up TW_Account_Number and Merchant:N and makes call to Processor:N 234 with Account_Number:N to redeem Value:N.

In another variation, a consumer can use a single identifier to redeem stored value from two or more merchant/retail stored value programs as part of a single transaction. Stated differently, a consumer can, via a traditional point of sale system (or an enhanced point of sale system), have two or more merchant/retailed stored value programs debited for a single transaction (such as purchasing bundled dinner/movie vouchers). In such an arrangement, a user attempts to redeem Value:1 at Merchant:1 POS system 210. The POS system 210 passes Value:1, Merchant:1 identifier and Account_Number:A to TW server 220. The TW Server 220 looks up, using one or more mapping tables, TW_Account_Number and Merchant:1 and makes call to Backend Processor:1 230 and Backend Processor:1 232 with Account_Number:1 to redeem, in the aggregate, Value:1. The mapping table can specify (which can be solely based on the aggregate value amount (e.g., $49.98) or it can be based on a combination of Merchant:1 and aggregate value amount (i.e., a specific mapping table can be associated with Merchant:1) how Value:1 can be apportioned between Backend Processor:1 230 and Backend Processor:2 232. In other implementations, the POS system 210 can also pass one or more item identifiers characterizing the multiple items being purchased as part of the transaction and such identifier(s) can be used in a mapping table in order to determine how to apportion the value redemptions from the Backend Processors 230, 232, 234. The TW server 220 then sends data to the POS system 210 indicating that the proposed transaction was approved. Stored value accounts can be activated or stored value can be added to an account (i.e., “activated”, etc.) corresponding to two or more backend processors 230, 232 in a similar manner.

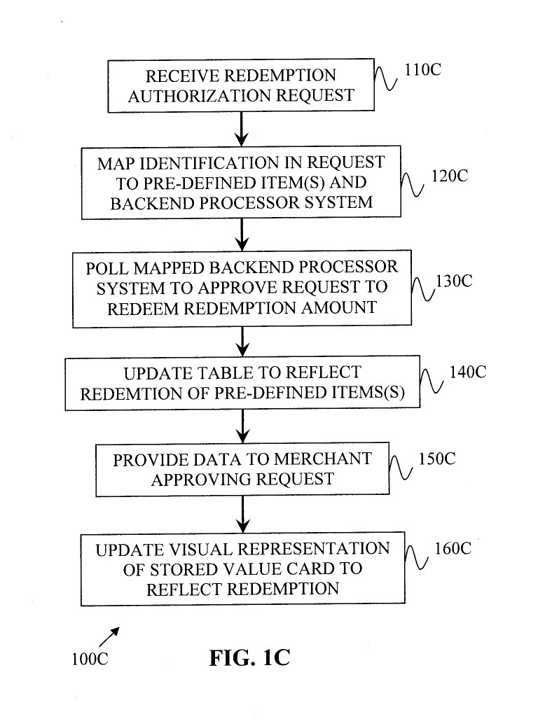

With reference to the diagram 300 of FIG. 3, there are also scenarios in which a consumer need only carry a single identifier to participate in multiple product/service stored value programs for a single merchant/retailer. For example, a single stored value card can be used to redeem “Movie and Popcorn” using a single movie theater stored value program. The introduction of account numbers with buckets is analogous to an array type variable in software programming. Each bucket within a gift card account number array 310 can have different types of values such as ACCT_NUM[0]=Large Popcorn 320, ACCT_NUM[1]=Medium Soft Drink 322, ACCT_NUM[N]=Item 324. Each element 320-324 of the array can hold counts representing the amount of credit for each bucket (e.g., Value=1, Value=2, etc.).

100291 A single account identifier can be obtained or provided at a POS terminal 210. The POS terminal 210 via web service (or other type of call) access the TW server 210 which can include or be coupled to a database table mapping the identifier to more than one stored value account. Accounts can be appropriately deducted per the transaction. For example a single card to redeem “Movie and Popcorn” using a movie theater chain stored value program.

The following describes data exchange in scenarios in which a single identifier can be used across multiple stored value buckets. Referring to FIGS. 2-3, a single account number (TW_Account_Number) can be registered/mapped on the TW server 220 to multiple value buckets 320, 322, 324 (Bucket:1, Bucket:2, Bucket:N) with stored values (Value:1, Value:2, Value:N). A user can attempt to redeem Value:1 from Bucket:1 320 at the POS system 210. The POS system 210 passes Bucket:1 320 (or data characterizing same) and TW_Account_Number identifier to be redeemed to TW server 220. Thereafter, the TW server 220 looks up in at least one mapping table Bucket:1 320 and TW_Account_Number to redeem Value:1 (which in turn results in TW server 210 sending data to the POS system 210 indicating the transaction has been approved). Similarly, in other cases, a user can attempt to redeem Value:N from Bucket:N 324 at another merchant POS system (not shown). This POS system can pass Bucket:N 324 and TW_Account_Number identifier to be redeemed to TW server 210. The TW server 210 then looks up Bucket:N 324 and TW_Account_Number to redeem Value:N (and data characterizing such redemption can be sent by the TW server 220 to the corresponding POS system).

In some implementations, a consumer need only carry a single identifier (e.g., phone number, physical stored value card, electronic representation of stored value card, etc.) to participate in both multiple merchant/retail stored value programs and multiple product/service stored value programs. For example, a single stored value card can be used to redeem “Dinner and two movie tickets, two soft drinks and a large popcorn” at a movie theater chain and at a restaurant chain using a combo stored value program. Such an arrangement can provide that buckets (i.e., the mapping table, etc.) on the TW server 220 would, rather than specifying values, would hold third party processor (e.g., backend processors 230, 232, 234, etc.) account numbers (which in turn at the corresponding backend processor 230, 232, 234 would have an associated stored value).

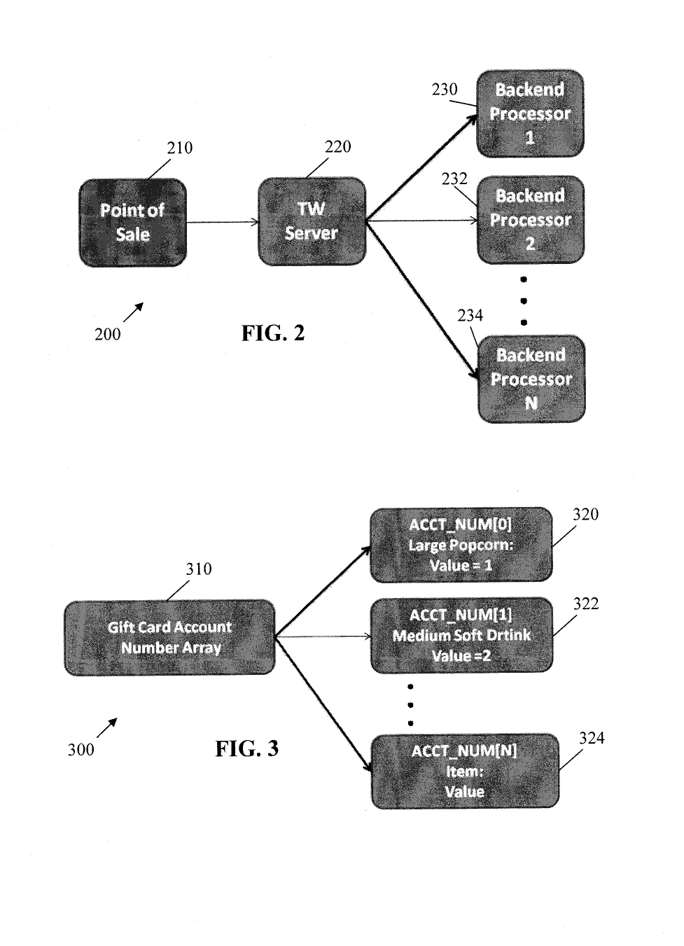

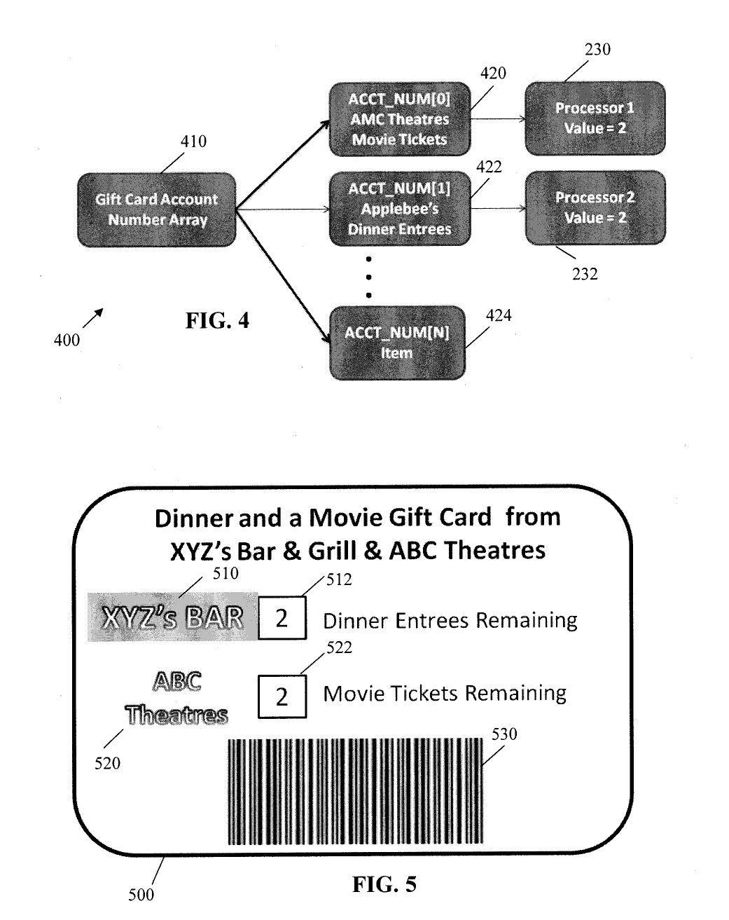

With reference to FIGS. 2 and 4, a single account number (TW_Account_Number) 410 can be registered/mapped on the TW server 220 to multiple value buckets (Bucket:1, Bucket:2, Bucket:N) 410, 412, 414 which map to multiple (Merchants:1, Merchants:2, Merchants:N) which run on third party backend processors (Processor:1, Processor:2, Processor:N) 230, 232 with stored values (Value:1, Value:2, Value:N). A user attempts to redeem Value:1 412 from Bucket:1 at Merchant:1 POS system 210. The POS system 210 passes Bucket:1 412 and TW_Account_Number identifier to be redeemed to TW Server 220. The TW server 220 looks up Bucket:1 412 from TW_Account_Number to redeem Value:1 on Backend Processor:1 220. Similarly, a user attempts to redeem Value:N from Bucket:N at Merchant:N POS system (not shown). The POS system 210 passes Bucket:N and TW_Account Number identifier to be redeemed to the TW server 220. The TW server 220 looks up Bucket:N from TW_Account_Number to redeem Value:N on Processor:N.

In some implementations utilizing electronically displayed stored value cards, the displayed stored value card (i.e., the card itself or a characterization of same, etc.) can be modified or updated to reflect redemptions of bundled items (i.e., products and/or services). As an example, a stored value card is given for two movie tickets, a medium popcorn, two soft drinks, and a candy item. With reference to FIG. 4, a sample stored value card 400 is displayed. When the stored value card is first granted, an image is displayed which reflects each of the gifted items on a single screen and a corresponding number. In this case, the stored value card can include indicators referencing the merchants such as RESTAURANT CHAIN 510 and MOVIE CHAIN 520—each of such designations can be have one or more corresponding items such as DINNER ENTREES REMAINING 512 and MOVIE TICKETS REMAINING 522. In some implementations, the stored value card 500 can include a bar 530 or other mechanism which can facilitate redemption of the items 512, 522. When an amount is redeemed that corresponds to the gifted items, the image is modified to reflect the redemption (e.g., the designations 512, 522 or reduced or “Xed” out). Such an arrangement can also be used for loyalty cards such that each affirmative act undertaken by a consumer (such as the purchase of a sub sandwich, etc.) can be updated on a corresponding loyalty card (which may or may not correspond to a stored value card).

Stored value (Gift Card, Loyalty, Pre-Paid) processors typically use ISO 8583 standard to send & receive transaction requests. Within that request the account number (typically 19 digits) is sent along with the transaction type (activate, credit, debit, or balance, etc.). Stored value processors typically break up the account number into sections, for example:
First 6 digits assigned to merchant providing stored value
Next 4 digits are assigned to a BIN range of cards
Last 9 digits assigned to account number identifying unique account on merchant database

The following provides yet another sample workflow to aggregate multiple merchants on a single account number using existing POS redemption technology (and ISO 8583 standard). Note that the ISO-8583 standard allows for varying length account numbers, but the typical length is 19 digits which is used in this example.
1. Create a new “Merchant” ID for users within the system and assign it a unique 5 digit merchant number (99999).
2. Assign the following 4 numbers to a secret user assigned PIN to be used at the POS for redemption. Reserve (0000) for card accounts not requiring a PIN for use.
3. Assign the remaining 10 digits to the user's mobile phone number (555-555-5555). Mobile phone numbers are unique within the United States and with the TW/transaction server platform.

At the POS rather than swipe a traditional gift card, the user/operator can enter in the phone number (555-555-5555) and secret PIN (1234) via manual entry. The POS software then constructs the account number in the following format: Example: 99999-1234-555-555-5555.

The 19 digit sequence is expected by the gift card processor and can travel using the existing infrastructure. Once the backend gift card processor receives the request and sees the pre-appended (99999) numbers it knows to look up the traditional gift card account number and return the expected responses to the POS.

Users can register all their gift cards on a website portal using their phone number as their account ID. On the portal they can register their phone number and create a PIN key. The phone number and secret PIN now can reference all the registered gift cards. Once they do that they can remove all the plastic from their wallets and use their mobile phone for redemption across all the merchants they registered with.

A typical process flow of aggregating multiple cards on multiple retailers using the process is as follows:
1) A user receives an MOVIE CHAIN gift card (ACCT#1) to their mobile phone (555-555-5555) or email via the TW/transaction server platform.
2) The user registers the MOVIE CHAIN gift card (ACCT#1) at a pre-defined web portal (gift card portal) and registers their mobile number and assigns a secret PIN (1234).
3) The user has a SPORTING GOODS CHAIN plastic gift card (ACCT#2) with a value of $50 and registers that card by typing the account number into the web portal.
4) The user has another SPORTING GOODS CHAIN plastic gift card (ACCT#3) with a value of $10 and registers that card by typing the account number into the website portal.
5) The user goes to redeem $100 of value at SPORTING GOODS CHAIN by entering the phone number (555-555-5555) and secret PIN (1234) into the POS.
6) The POS transmits a debit of $100 for account number 99999-1234-555-555-5555 to stored value processor.
7) Stored value processor recognizes the 99999 header of the account number and forwards request to TW/transaction server platform.
8) TW/transaction server does a look-up for any SPORTING GOODS gift cards accounts on the TW/transaction server platform.
9) TW/transaction server debits $10 from ACCT#3 and $50 from ACCT#2 and returns a complete debit of $60 back to stored value processor.
10) The stored value processor returns the $60 debit to the POS and the customer pays the remaining $40.
11) The user now can go to MOVIE CHAIN to redeem ACCT#1 using the same process as SPORTING GOODS CHAIN.

Various aspects of the subject matter described herein may be realized in digital electronic circuitry, integrated circuitry, specially designed ASICs (application specific integrated circuits), computer hardware, firmware, software, and/or combinations thereof. These various aspects may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a backend component (e.g., as a data server), or that includes a middleware component (e.g., an application server), or that includes a front-end component (e.g., a client computer having a graphical user interface or a Web browser through which a user may interact with an implementation of the subject matter described herein), or any combination of such backend, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Furthermore, the processes and systems described herein can utilize one or more of physical cards that include account numbers (e.g., a card with a magnetic strip that has the account number encoded therein), electronic representations of gift cards (e.g., wireless gift cards, etc.), or identifiers associated with account numbers such as mobile phone telephone numbers. In addition, it will be appreciated that multiple gift/loyalty card accounts can be associated or aggregated with a single account number. Other embodiments may be within the scope of the following claims.

What is claimed is:

1. A method comprising:
receiving, from a merchant system by a transaction server, a redemption authorization request associated with a stored value account, the request identifying a merchant associated with the merchant system, a redemption amount, and an identification associated with the stored value account;
accessing, by the transaction server, at least one database table to map the identification to one of a plurality of backend processor systems, the stored value account being able to redeem stored values from each of the plurality of backend processor systems;
polling, by the transaction server, the mapped backend processor system to redeem the redemption amount from the stored value account for the benefit of the merchant system; and
providing, by the transaction server to the merchant system, data approving or rejecting the request based on the polling.

2. A method as in claim 1, wherein the identification associated with the stored value account is a mobile phone number.

3. A method as in claim 2, wherein a visual representation of the stored value account is displayed on a mobile phone associated with the mobile phone number, and wherein the visual representation reflects whether the request was approved or rejected.

4. A method as in claim 2, further comprising: authenticating, at a mobile phone associated with the mobile phone number, the request by a user of the mobile phone.

5. A method as in claim 1, wherein the identification associated with the stored value account is an account number obtained by swiping a physical stored value card at the merchant system or at a swiping device coupled to the merchant system or placing a stored value card in proximity to a reader device at the merchant system that does not require contact with the stored value card.

6. A method as in claim 1, wherein the identification associated with the stored value account is obtained by scanning an electronic representation of a stored value card.

7. A method as in claim 6, wherein the stored value card is rendered on a display of a mobile phone.

8. A method comprising:
receiving, from a merchant system by a transaction server, a redemption authorization request associated with a stored value account, the request identifying a merchant associated with the merchant system, a redemption amount, and an identification associated with the stored value account;
accessing, by the transaction server, at least one database table to map the identification to at least two backend processor systems and to associate a portion of the redemption amount to each of the least two backend processor systems;
polling, by the transaction server, the at least two mapped backend processor systems to redeem the associated portion of the redemption amount from the stored value account for the benefit of the merchant system; and
providing, by the transaction server to the merchant system, data approving or rejecting the request based on the polling.

9. A method as in claim 8, wherein the identification associated with the stored value account is a mobile phone number.

10. A method as in claim 9, wherein a visual representation of the stored value account is displayed on a mobile phone associated with the mobile phone number, and wherein the visual representation reflects whether the request was approved or rejected.

11. A method as in claim 9, further comprising: authenticating, at a mobile phone associated with the mobile phone number, the request by a user of the mobile phone.

12. A method as in claim 8, wherein the identification associated with the stored value account is an account number obtained by swiping a physical stored value card at the merchant system or at a swiping device coupled to the merchant system or placing a stored value card in proximity to a reader device at the merchant system that does not require contact with the stored value card.

13. A method as in claim 8, wherein the identification associated with the stored value account is obtained by scanning an electronic representation of a stored value card.

14. A method as in claim 13, wherein the stored value card is rendered on a display of a mobile phone.

15. A method comprising:
receiving, from a merchant system by a transaction server, a redemption authorization request associated with a stored value account, the request identifying a merchant associated with the merchant system, a redemption amount, and an identification associated with the stored value card;
accessing, by the transaction server, a database table to map the redemption amount with at least one of a plurality of pre-defined items and to map the identification with at least one of a plurality of backend processor systems;
polling, by the transaction server, the mapped at least one backend processor system to redeem the redemption amount from the stored value card for the benefit of the merchant system;
updating, by the transaction server, the at least one database table to reflect the redemption of stored value corresponding to the mapped at least one pre-defined item; and
providing, by the transaction server to the merchant system, data approving the request.

16. A method as in claim 15, further comprising:
updating a visual representation of a payment card corresponding to the stored value account to reflect the redemption of the at least one pre-defined item.

17. A method as in claim 15, wherein the database tables maps the identification to at least two backend processor systems and associates a portion of the redemption amount to each of the least two backend processor systems; and the transaction servers polls the at least two mapped backend processor systems to redeem the associated portion of the redemption amount from the stored value account for the benefit of the merchant system.

18. A system comprising:
a merchant system comprising at least one data processor;
a transaction server comprising at least one data processor;
a plurality of backend processor systems each comprising at least one data processor; and
at least one data store;
wherein:
a redemption authorization request associated with a stored value account is received from the merchant system by the transaction server, the request identifying a merchant associated with the merchant system, a redemption amount, and an identification associated with the stored value account;
at least one database table stored in the at least one data store is accessed by the transaction server to map the identification to one of a plurality of backend processor systems, the stored value account being able to redeem stored values from each of the plurality of backend processor systems;
the mapped backend processor system is polled by the transaction server to redeem the redemption amount from the stored value account for the benefit of the merchant system; and
data approving or rejecting the request based on the polling is provided by the transaction server to the merchant system.

19. A system as in claim 18, further comprising:
a mobile phone providing a visual representation of a stored value card associated with the stored value account.

20. A system as in claim 18, further comprising:
a mobile phone associated with the stored value account, wherein a user of the mobile phone authenticates the request using the mobile phone.
